(19) United States
(12) Patent Application Publication
(10) Pub. No.: US 2016/0032777 A1
(43) Pub. Date: Feb. 4, 2016

(54) COMPONENT ARRANGEMENT OF A GAS TURBINE

(71) Applicant: MTU Aero Engines AG, Munich (DE)

(72) Inventor: Stefan Sasse, Petershausen (DE)

(21) Appl. No.: 14/805,496

(22) Filed: Jul. 22, 2015

(30) Foreign Application Priority Data
Jul. 30, 2014 (EP) 14 179 141.8

(51) Int. Cl. F01D 25/24

(52) U.S. Cl. CPC F01D 25/243; F05D 2220/32; F05D 2230/60; F05D 2260/56

(57) ABSTRACT

The present invention relates to a component arrangement of a gas turbine, this arrangement having a first gas turbine component, in particular a first wall segment (10) of a gas turbine duct casing; a second gas turbine component that can be joined thereto, in particular a second wall segment (20) of a gas turbine duct casing, with a flange (21), which is particularly bent; and an eccentric clamping element (30), which is mounted rotatably about an axis of rotation (A) on the first gas turbine component and has an eccentric contour portion (31), whose radial distance (r) to the axis of rotation varies by an angle (φ) about the axis of rotation, in order to press the flange (21) of the second gas turbine component (20) against the first gas turbine component, in particular to clamp it between the first gas turbine component and the eccentric contour portion (31).

The present invention relates to a component arrangement of a gas turbine, this arrangement having a first and a second component; a method for joining the first and second components of such a gas turbine component arrangement; as well as a gas turbine, in particular an aircraft engine, having such a gas turbine component arrangement.

A plurality of components must be joined together in gas turbines. Thus, for example, according to in-house practice, so-called fairings and panels of turbine center frames (TCF) have previously been joined together in such a way that threaded bolts have been soldered in the fairings onto which clamping plates are clamped. The present invention can be used in particular for such fairings and panels; however it is explained below on an example of how it can also be used for joining other components of a gas turbine.

An object of one embodiment of the present invention is thus to make available a gas turbine having at least two components that are joined together.

This object is achieved by a component arrangement of a gas turbine having the features of claim 1. Claims 10, 11 place under patent protection a method for joining a first and a second component of such a gas turbine component arrangement, as well as a gas turbine, in particular an aircraft engine, having such a gas turbine component arrangement. Advantageous embodiments of the invention are the subject of the dependent claims.

According to one aspect of the present invention, a gas turbine component arrangement has a first gas turbine component and a second gas turbine component that is joinable or especially joined therewith, particularly an arrangement that is detachable nondestructively.

The first gas turbine component can particularly be a first wall segment, particularly a so-called fairing or panel, of a gas turbine duct casing, in particular of a turbine center frame between a first and a second turbine; the second gas turbine component corresponds particularly to a second wall segment, especially a panel or fairing, of the gas turbine duct casing.

The second gas turbine component has a flange, which, in one embodiment, overlaps a surface of the first gas turbine component joined to the second gas turbine component, or is provided for this purpose. In one embodiment, this surface of the first gas turbine component is an outer surface facing away from a gas duct defined by the gas turbine components or perpendicular to the axis of rotation of the gas turbine.

In one embodiment, the flange of the second gas turbine component is bent and/or partially overlaps the first gas turbine component joined to the second gas turbine component, or is provided for this purpose. Additionally or alternatively, an edge of the first gas turbine component that is overlapped by the flange or is provided for this purpose, can also be bent.

According to one aspect of the present invention, the gas turbine component arrangement has an eccentric clamping element, which is or will be mounted rotatably around an axis of rotation on the first gas turbine component, and has an eccentric contour portion, whose radial distance perpendicular to this axis of rotation varies by an angle about the axis of rotation, particularly in order to press the flange of the second gas turbine component, in particular at least without play, against the first gas turbine component or its surface overlapped by the flange, in particular to clamp the flange of the second gas turbine component between the first gas turbine component or its surface overlapped by the flange and the eccentric contour portion. Correspondingly, in one embodiment, the flange of the second gas turbine component is or will be pressed via the eccentric contour portion, in particular at least without play, against the first gas turbine component or its surface overlapped by the flange; in particular, the flange of the second gas turbine component is or will be clamped between the first gas turbine component or its surface overlapped by the flange and the eccentric contour portion.

In this way, in one embodiment, the clamping or clamping force is or will be so small (adjusted or pre-defined) that the flange of the second gas turbine component can slide, particularly in the direction of the axis of rotation, relative to the first gas turbine component or its surface overlapped by this flange, in order to be able to equilibrate thermal expansions. The clamping force, in particular, can also be equal to zero, at least substantially equal to zero.

Likewise, the eccentric contour portion can also bring about a clamping force that is different from zero, preferably a small clamping force, or is equipped for this purpose.

In one embodiment, a friction coefficient between the flange of the second gas turbine component and the first gas turbine component or its surface overlapped by this flange and/or between the flange of the second gas turbine component and the eccentric contour portion is smaller in the direction of the axis of rotation than in the peripheral direction or crosswise to this latter, in order to facilitate a sliding in the direction of the axis of rotation in relation to a rotation of the two gas turbine components perpendicular thereto.

In one embodiment, the eccentric contour portion is of circular segment shape, at least in sections, wherein a central point of this circular segment is distanced from the axis of rotation, so that a radial distance of the eccentric contour portion perpendicular to the axis of rotation varies by an angle around the axis of rotation. In one embodiment it is advantageous to create an eccentric contour portion in the shape of a circular segment. Additionally or alternatively, in one embodiment, a radial distance r of the eccentric contour portion to the axis of rotation can vary linearly, at least in sections, with the angle of rotation φ (r=k ·φ; k=constant). In one embodiment, a uniform adjustment of the pressing, in particular the clamping, can be achieved thereby. Additionally or alternatively, in one embodiment, the eccentric contour portion can be formed in cam shape, at least in sections.

Preferably, the radial distance varies monotonically with the angle, at least in sections, in particular, strongly monotonically or continuously. It is understood hereby by persons skilled in the art that the radial distance, at least in an angular region, for a larger angle in a pressing direction of rotation is always at least as great (monotonic), particularly continually greater (strongly monotonic) than in the case of a smaller angle in the pressing direction of rotation. In one embodiment, a radial distance of the eccentric contour portion and thus a pressing, particularly a play and/or a clamping, can be continuously changed and thus can be adjusted thereby.

In order to press the flange of the second gas turbine component by the eccentric contour portion without play against the first gas turbine component, in particular to clamp it between the first gas turbine component and the eccentric contour portion, in one embodiment, the gap, which is particularly radial, between the eccentric contour portion and the surface of the first gas turbine component overlapped by the flange, with the flange disposed in this gap, forms a play-free fit, preferably an interference fit or press fit for at least one pressing angle of rotation of the eccentric clamping element relative to the first gas turbine component. In particular, it is presently understood by this that the gap is at most equal to, and particularly is smaller than, a wall thickness of the undeformed flange. In an enhancement, the gap between the eccentric contour portion and the surface of the first gas turbine component overlapped by the flange, with the flange disposed in this gap, starting from a minimum pressing angle of rotation of the eccentric clamping element relative to the first gas turbine component with or for an angle of rotation of the eccentric clamping element, this angle increasing in the pressing direction of rotation and amounting preferably to at least 15°, forms a particularly strongly clamping interference fit or press fit that becomes more constricted or the gap decreases with an angle of rotation that increases in the pressing direction of rotation over an angular region, which preferably amounts to at least 15°. Additionally or alternatively, the gap between the eccentric contour portion and the surface of the first gas turbine component overlapped by the flange, with the flange disposed in this gap, for at least one play angle of rotation of the eccentric clamping element, in particular from a maximum play angle of rotation of the eccentric clamping element relative to the first gas turbine component with or for a decreasing angle of rotation of the eccentric clamping element when viewed in the pressing direction of rotation, over an angular region that preferably amounts to at least 15°, forms a snug fit or a loose fit, in particular a fit that becomes looser. In particular, it is presently understood that the gap is larger than a wall thickness of the undeformed flange.

At first, by disposing the flange of the second gas turbine component between the surface of the first gas turbine component and the eccentric contour portion, and then by rotating the eccentric contour portion around the axis of rotation in a pressing angle of rotation, the flange will be pressed by the eccentric contour portion against the first gas turbine component, in particular the flange will be clamped between the first gas turbine component and the eccentric contour portion, and thus the first and second gas turbine components will be joined together or fastened to one another.

In one embodiment, the eccentric contour portion is disposed or mounted rotatably on a hub, which is or will be joined to the first gas turbine component, in particular in a manner resistant to rotation, preferably cohesively, and especially integrally. In another embodiment, in contrast, the eccentric clamping element has a shaft joined to the eccentric contour portion, in particular joined in a manner resistant to rotation, preferably cohesively, especially integrally, and the shaft is or will be mounted movably around the axis of rotation in a borehole of the first gas turbine component. In one embodiment, by rotating the shaft joined to the eccentric contour portion in a rotation-resistant manner, the angle of rotation of the eccentric contour portion can be changed advantageously, and thus the flange can be pressed against the first gas turbine component, in particular, it can be clamped with it.

In one embodiment, the shaft terminates in the borehole; in particular, it can be or can become screwed into or with the latter. In another embodiment, the shaft passes through the (through-)borehole and is or will be screwed together with a nut on a side facing away from the eccentric contour portion. In one embodiment, the nut is supported directly or via an intermediate element, in particular a washer, on the first gas turbine component, and in one embodiment can thus secure the eccentric clamping element to the latter against rotation, in particular by a friction fit.

In one embodiment the eccentric clamping element is or will be disposed or mounted in a rotatable manner on an outer side of the first gas turbine component, in particular on a projecting radial flange of the gas turbine component, this outer side particularly facing away from a gas duct defined by the components. In particular, the borehole in which the shaft of the eccentric clamping element is or will be mounted, can be or can become arranged in a radial flange projecting on the outer side of the first gas turbine component. In one embodiment, the eccentric clamping element advantageously can be rotated from the outer side and thus the joined components can be (de)mounted or adjusted thereby. In particular, if an inner side lying opposite to the outer side of the first and/or second gas turbine component defines a gas duct, then a disruption of the gas duct by the eccentric clamping element can be avoided, and/or the (de)mounting can be simplified.

In one embodiment, the component arrangement of the gas turbine has an element for securing against rotation found between the eccentric clamping element and the first gas turbine component. A pressing that is adjusted by a rotation of the eccentric clamping element around the axis of rotation, in particular a clamping that is adjusted or induced by a rotation of the eccentric clamping element around the axis of rotation can be secured in this way.

The element for securing against rotation can be friction fit, particularly by a nut screwed to the eccentric clamping element, this nut being supported on the first gas turbine component and clamping the eccentric clamping element against the first gas turbine component so that the eccentric clamping element and the first gas turbine component are or will be secured against rotation by a friction fit. Additionally or alternatively, the element for securing against rotation can be form-fit and, in an enhancement, can have one or more projections in the direction of the axis of rotation, these projections being spaced apart in the peripheral direction; this or these projection(s) are (able to) engage selectively, or with different angles of rotation of the eccentric clamping element around the axis of rotation, in corresponding recesses. Correspondingly, in one embodiment, the form-fitting element for securing against rotation has several discrete angles of rotation spaced apart from each other in the peripheral direction, and the eccentric clamping element can be or can become secured against rotation selectively or alternatively on the first gas turbine component by these angles. A pressing, in particular a clamping, can be adjusted in discrete steps in this way. As long as it is not stated otherwise, the direction indications “radial” and “peripheral direction” in general refer to the axis of rotation of the eccentric clamping element.

In an enhancement, the element for securing against rotation has a lock washer (on the side of the clamping element) having several teeth spaced at a distance from one another in the peripheral direction, and the element is or will be secured against rotation in form-fitting manner on the eccentric clamping element. Additionally or alternatively, in an enhancement, the element for securing against rotation has a lock washer (on the side of the gas turbine) having several teeth spaced at a distance from one another in the peripheral direction, and the element is or can become secured against rotation in form-fitting manner on the first gas turbine component. By engaging the teeth of one lock washer in corresponding recesses in the other lock washer or the eccentric clamping element or the first gas turbine component, as explained above, the eccentric clamping element can be or can become secured against rotation selectively or alternatively on the first gas turbine component in several discrete rotation angles distanced from one another in the peripheral direction. Advantageously, the lock washers can be produced separately from the eccentric clamping element or the gas turbine component and can be or can become secured against rotation on the latter in form-fitting manner, in particular by one or more projections and/or recesses extending parallel to the axis of rotation, which especially facilitates the production of the eccentric clamping element or the gas turbine component.

In one embodiment, the eccentric contour portion is formed spherically in the direction of the axis of rotation. In an enhancement, in a section through the axis of rotation, the eccentric contour portion has a constant or variable radius which is convex toward the flange. In one embodiment, advantageously, a tolerance, in particular a misalignment, can be compensated for in this way, and/or a surface pressing can be optimized, in particular it can be increased.

In one embodiment, the axis of rotation about which the eccentric clamping element can be rotated or is rotated, extends tangentially, at least substantially tangentially, to a direction of rotation of the gas turbine, or is perpendicular, at least substantially perpendicular, to an axis of rotation of the gas turbine. In one embodiment, a compact structural design and/or advantageous (de)mounting can be provided in this way. In another embodiment, the axis of rotation of the eccentric clamping element can also be inclined against the axis of rotation of the gas turbine, or can be parallel, at least substantially parallel, to it.

Additional advantageous enhancements of the present invention can be taken from the dependent claims and the following description of preferred embodiments. For this purpose and partially schematized:

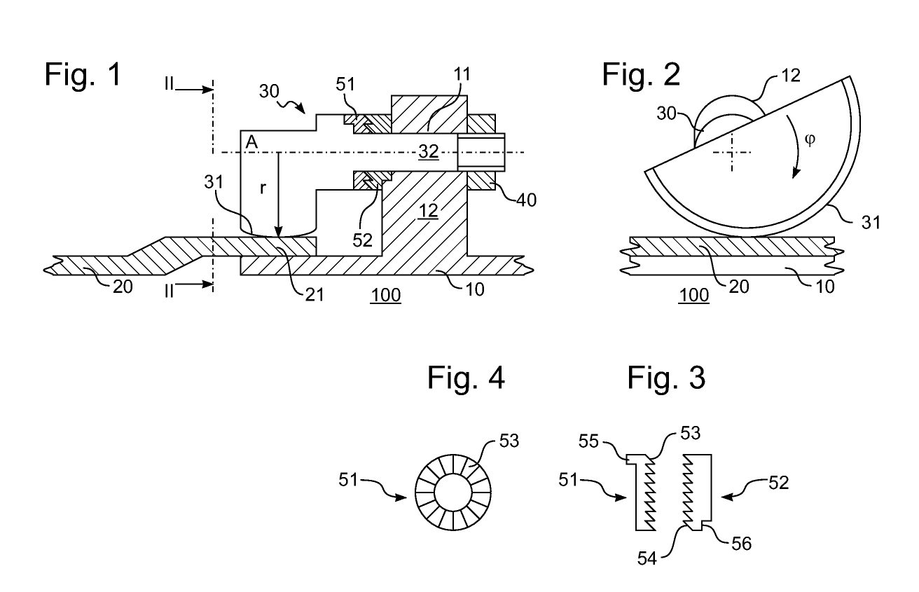

FIG. 1 shows a component arrangement of a gas turbine according to an embodiment of the present invention in a section perpendicular to an axis of rotation of the gas turbine;

FIG. 2 shows a section along line II-II in FIG. 1;

FIG. 3 shows a lateral view of a lock washer on the side of the clamping element and a lock washer on the side of the gas turbine component, of an element for securing the gas turbine component arrangement against rotation; and

FIG. 4 shows a top view onto the lock washer on the side of the clamping element.

FIG. 1 shows a component arrangement of a gas turbine according to an embodiment of the present invention in a section perpendicular to an axis of rotation of the gas turbine, this arrangement having a first gas turbine component in the form of a fairing 10 of a TFC and a second gas turbine component in the form of a panel 20 with a bent flange 21 that is joined thereto. Likewise also, the first gas turbine component 10 can be a panel and the second gas turbine component 20 can be a fairing.

Flange 21 overlaps an outer surface—facing away from a gas duct 100 defined by the gas turbine components 10, 20, and perpendicular to an axis of rotation (perpendicular on the plane of the drawing of FIG. 1) of the gas turbine—of the first gas turbine component 10 joined to the second gas turbine component.

The gas turbine component arrangement has an eccentric clamping element 30, which is mounted rotatable about an axis of rotation A on the first gas turbine component 10 and has an eccentric contour portion 31, which, in the direction of the axis of rotation, is spherically shaped and whose radial distance r perpendicular to the axis of rotation A varies by an angle φ about this axis of rotation, in order to press the flange 21 of the second gas turbine component 20 without play against the surface of the first gas turbine component 10, which is overlapped by the flange, preferably to clamp the flange between the surface of the first gas turbine component 10, which is overlapped by the flange, and the eccentric contour portion 31.

The eccentric contour portion 31, as can be recognized in the section of FIG. 2, is shaped like a circular segment in the exemplary embodiment and is distanced from the axis of rotation. Correspondingly, the radial distance r in sections varies strongly monotonically or continuously with the angle φ.

In the case of a pressing angle of rotation of the eccentric clamping element 30 relative to the first gas turbine component 10, which is shown in FIGS. 1, 2, the gap, with flange 21 disposed in the gap, forms an interference fit or press fit between the eccentric contour portion 31 and the surface of the first gas turbine component 10, which is overlapped by the flange 21; this press fit will be more constricted or clamped more strongly with increasing angle of rotation in the pressing direction of rotation (clockwise in FIG. 2). With a smaller angle of rotation, when viewed in the pressing direction of rotation (which is not shown), in contrast, the gap, with the flange disposed therein, forms a loose fit or is greater than a wall thickness of the undeformed flange.

The eccentric clamping element 30 has a shaft 32, which is formed integrally with the eccentric contour portion 31 and, rotatably about the axis of rotation A, passes through a through-borehole 11 in a radial flange 12 projecting on an outer side of the first gas turbine component facing away from the duct 100 (top in FIGS. 1, 2), and is screwed with a nut 40 on a side facing away from the eccentric contour portion (right in FIG. 1). In the embodiment, the nut is supported directly on the first gas turbine component 10.

The gas turbine component arrangement has a form-fitting element for securing against rotation having a lock washer 51 on the side of the clamping element and a lock washer 52 on the side of the gas turbine component between the eccentric clamping element 30 and the first gas turbine component 10, which are depicted individually in FIGS. 3, 4.

The lock washer 51 on the side of the clamping element (left in FIG. 3) has several projections or teeth 53 (see FIGS. 3, 4) which are spaced apart in the peripheral direction, and which alternatively or with different angles of rotation of the eccentric clamping element 30 about the axis of rotation A can engage in corresponding recesses between teeth 54 of the lock washer 52 on the side of the gas turbine component.

The lock washer 51 on the side of the clamping element and the lock washer 52 on the side of the gas turbine component are produced separately from the eccentric clamping element or the gas turbine component and are secured against rotation on the latter in form-fitting manner by projections 55 and recesses 56 (see FIG. 1).

In order to join together the first and second gas turbine components 10, 20, first the flange 21 is disposed with play in the gap between the first gas turbine component 10 and the eccentric contour portion 31, and the eccentric contour portion 31 then rotates about the axis of rotation A in a pressing angle of rotation, which is shown in FIGS. 1, 2, in which it presses the flange without play against the first gas turbine component 10, and preferably clamps the flange. Subsequently, the nut 40 is tightened and thus secures against rotation the eccentric clamping element 30 on the first gas turbine component 10 via the lock washers 51, 52 that engage in each other in form-fitting manner, and in this way, secures the pressing, in particular the clamping, which is induced by the eccentric clamping element 30. In this case, the clamping force is adjusted so that the flange 21 can slide in the gap between the first gas turbine component 10 and the eccentric contour portion 31 to equilibrate thermal expansions.

Although exemplary embodiments were explained in the preceding description, it shall be noted that a plurality of modifications is possible. In addition, it shall be noted that the exemplary embodiments only involve examples that in no way shall limit the scope of patent protection, the applications and the construction. Rather, a guide is given to the person skilled in the art by the preceding description for implementing at least one exemplary embodiment, whereby diverse changes, particularly with respect to the function and arrangement of the described components, can be carried out without departing from the scope of patent protection, as it results from the claims and combinations of features equivalent to these.

### LIST OF REFERENCE CHARACTERS

10 First gas turbine component
11 Through-borehole
12 Radial flange
20 Second gas turbine component
21 Flange
30 Eccentric clamping element
31 Eccentric contour portion
32 Shaft
40 Nut
51 Lock washer on the side of the clamping element
52 Lock washer on the side of the gas turbine component
53, 54 Teeth
55 Projection
56 Recess
100 Gas duct
φ Angle
r Radial distance
A Axis of rotation

1. A component arrangement of a gas turbine, comprising:
a first wall segment (10) of a gas turbine duct casing;
a second wall segment (20) of a gas turbine duct casing that can be joined thereto with a flange (21), which is bent; and
an eccentric clamping element (30) that is mounted rotatably about an axis of rotation (A) on the first gas turbine component and has an eccentric contour portion (31), whose radial distance (r) to the axis of rotation varies by an angle (φ) about the axis of rotation, in order to press the flange (21) of the second gas turbine component (20) against the first gas turbine component (10), to clamp it between the first gas turbine component (10) and the eccentric contour portion (31).

2. The gas turbine component arrangement according to claim 1, wherein the eccentric clamping element (30) has a shaft (32) which is joined to the eccentric contour portion (31), ire particular and resistant to rotation, this shaft being mounted rotatably about the axis of rotation (A) in a borehole (11) of the first gas turbine component (10).

3. The gas turbine component arrangement according to claim 2, wherein the shaft (32) passes through the borehole (11) and is screwed with a nut (40) on a side facing away from the eccentric contour portion.

4. The gas turbine component arrangement according to claim 1, wherein the eccentric clamping element (30) is disposed on an outer side of the first gas turbine component facing away from a gas duct (100) defined by the components (10, 20) on a projecting radial flange (12) of the first gas turbine component.

5. The gas turbine component arrangement according to claim 1, wherein an element for securing against rotation (51, 52), which is form-fitting, between the eccentric clamping element (30) and the first gas turbine component (10).

6. The gas turbine component arrangement according to claim 5, wherein the element for securing against rotation has a lock washer (51), which is secured against rotation in form-fitting manner (55) on the eccentric clamping element (30).

7. The gas turbine component arrangement according to claim 6, wherein the element for securing against rotation has a lock washer (52) that is secured against rotation in form-fitting manner (56) on the first gas turbine component (10).

8. The gas turbine component arrangement according to claim 1, wherein the eccentric contour portion (31) is designed spherically in the direction of the axis of rotation (A).

9. The gas turbine component arrangement according to claim 1, wherein the axis of rotation (A) extends substantially tangentially to a direction of rotation of the gas turbine.

10. The gas turbine component arrangement according to claim 1, wherein the eccentric clamping element (30) is rotated about the axis of rotation (A) in order to press the flange (21) of the second gas turbine component (20) against the first gas turbine component (10) to clamp it between the first gas turbine component (10) and the eccentric contour portion (30).

11. The gas turbine component arrangement according to claim 1, wherein the turbine component arrangement is configured and arranged in a gas turbine.

12. The gas turbine component arrangement according to claim 1, wherein the first gas turbine component is a fairing or panel of a turbine center frame between a first and a second turbine, and the second gas turbine component is a panel or fairing of the gas turbine duct casing.
